(19) United States
(12) Patent Application Publication
(10) Pub. No.: US 2009/0222249 A1
(43) Pub. Date: Sep. 3, 2009

(54) MODULAR VERIFICATION OF WEB SERVICES USING EFFICIENT SYMBOLIC ENCODING AND SUMMARIZATION

(75) Inventors: Chao Wang, Plainsboro, NJ (US); Fang Yu, Goleta, CA (US); Aarti Gupta, Princeton, NJ (US)

Correspondence Address: NEC LABORATORIES AMERICA, INC., 4 INDEPENDENCE WAY, Suite 200, PRINCETON, NJ, 08540, US

(73) Assignee: NEC Laboratories America, Inc., Princeton, NJ (US)

(21) Appl. No.: 12/395,955

(22) Filed: Mar. 2, 2009

Related U.S. Application Data
(60) Provisional application No. 61/033,126, filed on Mar. 3, 2008.

(51) Int. Cl. G06F 17/50

(52) U.S. Cl. 703/13

(57) ABSTRACT

A system and method for verifying a composition of interacting services in a distributed system includes generating a concurrent process graph (CPG) for processes in a system and symbolically encoding the CPG of each process to perform a reachability analysis. Symbolic summaries are generated for concurrently running processes based on the reachability analysis. Modular verification is conducted by utilizing the symbolic summaries of the processes to verify a system of interrelated processes.

### RELATED APPLICATION INFORMATION

This application claims priority to provisional application Ser. No. 61/033,126 filed on Mar. 31, 2008, incorporated herein by reference.

### BACKGROUND

1. Technical Field

The present invention relates to computer verification systems and methods and more particularly to a modular verification system for web services.

2. Description of the Related Art

The increased interest in web-based business process management has heightened the need for the development of automatic verification tools suitable to analyze complex concurrent behaviors among large-scale web services. Such systems consist of processes that can invoke other remote processes asynchronously or synchronously, as well as dynamically create local threads. These concurrent features, although well suited for implementing complex business tasks, yield interfered concurrent executions that are difficult to analyze and debug (prone to errors).

Most existing methods for verifying such concurrent systems rely on “automata production”. This approach does not scale well to large systems, because the approach models each process as an entity (called an automaton) and models the composition of interacting processes as a “product of automata”. Automaton production is known to cause scalability problems due to “state explosion”—the state space of a composite system is exponential in the number of its concurrent components.

There are also existing methods that compute process summaries (for web service integration and verification). However, the methods of computing process summaries are not efficient and not scalable to a large number of threads.

Among large-scale web services, services play an important role, serving as basic building blocks of inter-organizational cooperation. Business Process Execution Language (BPEL), used to compose these services, is one of the standard languages designed to enable universal interoperability. A BPEL process can dynamically invoke external services asynchronously or synchronously, as well as dynamically process concurrent threads internally.

A composite web service implemented in BPEL can thus be viewed as a distributed system with both multi-threading and message passing. These concurrent language constructs give the BPEL process the ability to execute complex concurrent tasks, while at the same time, the process yields concurrent executions that make the system difficult to analyze and prone to errors.

To tackle the difficult problem of analysis of a composite web service, a widely adopted approach models individual processes as variants of communicating finite automata or variants of Communicating Sequential Processes (CSP). In this approach, concurrent behavior is modeled by a product automaton, where the state space is exponential in the number of web services that are involved in the system. While model checking has been used to implicitly analyze concurrent behaviors, it suffers from state explosion. Since BPEL is designed for composing large distributed systems, state explosion limits the application of such verification techniques, and thus a more scalable model checking framework is worthy of investigation.

### SUMMARY

In accordance with the present principles, a scalable static checker is provided based on a novel symbolic encoding of interleaving execution semantics of BPEL processes, and a method for summarizing concurrent processes in terms of pre- and post-conditions. A modular verification framework utilizes these summaries for scalable verification. A new intermediate graph representation, called a Concurrent Process Graph (CPG), is introduced to model composite web services with multiple processes. The CPG can be considered an extension of a control flow graph, which handles concurrency. The CPG provides a clean representation of a set of BPEL processes and facilitates a simple definition of the formal semantics.

Summarizing concurrently running processes is not a trivial task, since it involves handling both internal multithreading and external message passing. There are two concurrent features in a composite web service. A first one comes from a flow construct in BPEL, which induces multiple threads that are executed concurrently. The concurrent behavior is modeled under interleaving semantics, where nodes associated with different threads are executed in arbitrary order. For analyzing threads, a disjunctive representation of the transition relation of the system is employed. Compared to the conventional conjunctive representation, the present encoding avoids the unnecessary addition of stuttering transitions in the composed system. This makes symbolic reachability analysis more efficient in practice.

A second concurrent feature comes from external service invocation, e.g., when one process invokes another by passing messages. For synchronous invocation, the invoker waits for the service to finish before it continues. For asynchronous invocation, an invoker executes in a non-blocking fashion and proceeds forward, waiting for the reply of the service at a future point. We provide summarization of the invoked service as a pair of weakest pre-condition and strongest post-condition.

Since the two processes are running in parallel and may share common messages, a naïve approach as in sequential procedure calls does not work, since read-write conflicts over common variables may invalidate the summaries. We address this problem by adding a special set of snapshots of the messages at the time of send/receive and composing a summary in terms of these auxiliary variables. At the point of composing, these variables are removed by existential quantification. Communication between the service and the invoker or other BPEL processes is limited, and hence concise summarization of remote processes is achievable.

A system and method for verifying a composition of interacting services in a distributed system includes generating a concurrent process graph (CPG) for processes in a system and symbolically encoding the CPG of each process to perform a reachability analysis. Symbolic summaries are generated for concurrently running processes based on the reachability analysis. Modular verification is conducted by utilizing the symbolic summaries of the processes to verify a system of interrelated processes. It should be understood that the present principles are applicable to any system analysis, such as, e.g., system composition optimization, etc.

A system and method of verification of services in a distributed system includes providing a system description of a plurality of processes to be executed concurrently. A concurrent process graph (CPG) is generated for the plurality of processes and the CPG is symbolically encoded to build symbolic transition relations for the plurality of processes. Symbolic summaries for concurrently running threads and processes are generated based on model checking and a reachability analysis. Modular verification is conducted for service composition by computing and utilizing the symbolic summaries of the threads and processes to provide a modular and scalable verification of a system of interrelated processes.

A system for verification of services in a distributed system includes a concurrent process graph (CPG) generated for the plurality of processes in a distributed system. A symbolic encoder is configured to symbolically encode the CPG of each process to perform a reachability analysis. A library of process summaries is stored in memory media. The process summaries represent concurrently running threads and processes based on reachable states. A modular verifier is configured to perform service composition by computing and utilizing the process summaries of the processes to modularly analyze an entire system of processes to determine dependencies and order of execution for the entire system of process.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram showing a method for modular verification of a system of interrelated and concurrently running processes in accordance with one embodiment;

FIG. 2 is a block diagram showing a system/method for performing modular verification of interrelated and concurrently running processes for web services or in other distributed systems in accordance with one embodiment;

FIG. 3 is a diagram showing a concurrent process graph (CPG) and an associated listing of messages in the graph in accordance with one illustrative example for a loan approval service;

FIG. 4 is pseudo code for a loan approval service diagrammed in FIG. 3;

FIG. 5 is a diagram showing rewriting of fork nodes, join nodes and link edges in a CPG in accordance with illustrative examples;

FIG. 6 is a diagram showing rewriting of link nodes in a CPG in accordance with an illustrative example;

FIG. 7 is pseudo code for encoding of interleaving semantics for the CPG of FIG. 3;

FIG. 8 is a diagram showing a portion of the CPG of FIG. 3 that is encoded and a corresponding listing of the symbolically encoded semantics of the CPG;

FIG. 9 is a diagram showing a process summary and composition for two processes where one process invokes the other; and

FIG. 10 is block/flow diagram for a method of modular verification in accordance with one illustrative embodiment.

### DETAILED DESCRIPTION OF PREFERRED EMBODIMENTS

A modular verification system and method are provided to analyze processes individually. If there is one process invoking another process, we first efficiently compute a concise summary of the invoked process, and then utilize the summary while analyzing an invoker process (avoid composing the two processes together). The present method reduces the number of concurrent operations that verification methods have to deal with each time.

The present embodiments of the modular verification method include a novel symbolic encoding to model the concurrency semantics of both threading and message passing, a symbolic method for summarizing concurrent processes, and a framework that utilizes a library of process summaries for property verification. The verification method is faster in run time and scales better to large systems.

In contrast to conjunctive transition relations, the present symbolic encoding avoids adding unnecessary global stuttering states from which all threads voluntarily stop making progress. An advantage is that this makes symbolic computation more efficient (faster). In bounded model checking, it is also easier to detect when to stop (when the method can stop with a proof that the model does not have an error).

Contrasted with the prior art, the present summarization method handles intra-process threading more efficiently and accurately. The methods are more scalable, because we only compute the set of reachable states of a process. Applying the present principles to the development of web service applications can improve the quality of these software products.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device). The medium may include a computer-readable medium such as a semiconductor or solid state memory, magnetic tape, a removable computer diskette, a random access memory (RAM), a read-only memory (ROM), a rigid magnetic disk and an optical disk, etc.

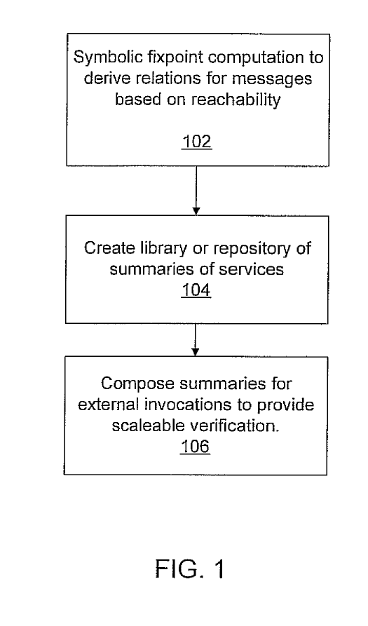

Referring now to the drawings in which like numerals represent the same or similar elements and initially to FIG. 1, an illustrative method for modular verification of Business Process Execution Language (BPEL) service composition is shown. In block 102, a symbolic fixpoint computation is performed to derive relations for incoming and outgoing messages for well-defined web services based on a reachability analysis. The relations are collected and serve as a repository of summarizations of individual web services in block 104. In block 106, the summaries of external invocations are composed, resulting in scalable verification of web service composition.

A symbolic encoding is provided for modeling the concurrency semantics of systems having both internal multi-threading and external message passing. A method for summarizing concurrently running processes is provided along with a modular verification framework that utilizes these summaries for scalable verification. These aspects of the present embodiments will be described in greater detail below.

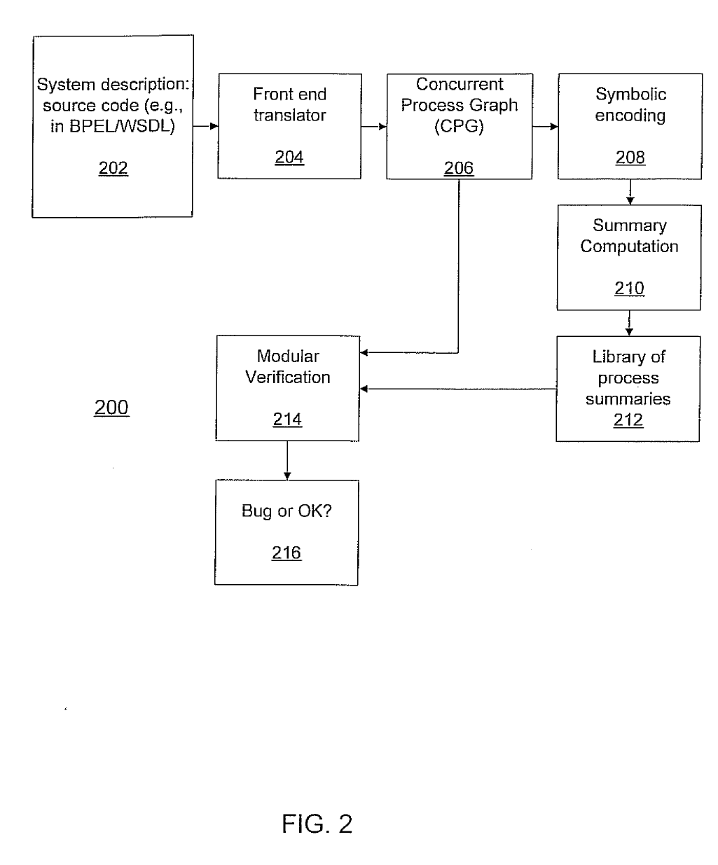

Referring to FIG. 2, a system 200 for conducting modular verification for web service composition is illustratively shown. A system description 202 is provided, preferably in source code. The source code may include BPEL, WSDL (Web Services Description Language) or other descriptions that may be suitable. BPEL and WSDL documents are parsed and necessary control and data flow information is extracted.

A front end translator 204 translates the code into a concurrent process graph 206. The concurrent process graph (CPG) 206 is employed to model the BPEL process(s). The CPG 206 is an extension of standard control flow graph for modeling sequential programs, with additional features to model concurrency constructs. The corresponding concurrent process graph (CPG) 206 is created. Depending on whether we apply monolithic verification or modular verification, we build symbolic transition relations for the processes by symbolic encoding 208. After symbolic encoding 208, we can employ a symbolic model checker for infinite state model checking and reachability analysis in block 208. An underlying symbolic library can handle models with both Boolean and unbounded integer variables. The symbolic form in one model embodiment is a composition of Binary Decision Diagrams and Polyhedra over linear constraints.

In monolithic model checking, all BPEL processes are put into a single CPG, on which symbolic reachability analysis is applied. However, in accordance with the present principles, a modular verifier 214 composes the invoked service in the invoker process by using summaries computed in a summary computation module 210, analyzes the invoker process symbolically, and then adds its summary to the service library 212. Given a set of un-analyzed services, we first conduct a dependency analysis of the invocations of processes to determine the order in which processes should be summarized. The modular verifiers scalably and modularly verifies the system of processes to determine whether there exists a bug or not in the process operations in block 216.

A process dependency graph G=(N,E) is a directed graph where each node nεN represents a process and each edge e=(n₁,n₂)εE indicates a channel through which n₁ receives a message from n₂. Given a (root) process that we want to analyze, we order the rest of the processes by computing a depth-first search spanning tree from the root process in the dependency graph. The order for summarization follows the order of the spanning tree, from leaf nodes to root.

CPG 206 has the capability of modeling both shared-variable multithreading and processes communicating by messages. Therefore, CPG 206 can serve as an intermediate representation of an individual BPEL process as well as a composite service including multiple interacting BPEL processes.

Definition: A concurrent process graph (CPG) is a tuple [symbol] N,E,Var,Chl,α,βγ [symbol] such that
N={n₁, . . . , nₖ} is a set of nodes.
E [symbol] N×N is a set of edges.
Var is a set of variables modeling the messages and predicates over messages.
Chl is a set of communication channels. Each channel chεChl corresponds to a unique send action (ch!v) and a unique receive action (ch?v)
α: N → {normal,fork,join} is a labeling function that maps a node to one of the three types.
β: E → {link,guard} is a labeling function that maps an edge to either a link or a guard.
γ: E → {assignment,ch!v, ch?v} is a labeling function that maps an edge to an action, which can be assignment, send or receive.

Let ch!v denote the sending of message v through channel ch, and let ch?v denote the receiving of that message into variable v. Let vεVar and exp be an expression in terms of variables in Var. We use S_{a sgn}={v:=exp} to denote the set of all possible assignment statements, and use S_{cond} to denote the set of all possible conditional expressions. Let guardεS_{cond} and assignment εS_{a sgn}.

A CPG node has one of the following three types:
normal: These nodes model the sequential execution of a thread. One of the incoming edges must be executed before the control is transferred to the node; from this node only one of the outgoing edges can be executed.
fork: A fork node represents the start of parallel execution of threads. One of the incoming edges must be executed before control is transferred to this node; from this node all the outgoing edges are executed simultaneously in one step.
join: A join node represents the end of parallel execution of threads. All incoming edges must be executed (simultaneously in one step) before control is transferred to this node; from this node only one of the outgoing edges can be executed.

Two distinct sources of concurrency in BPEL can be modeled by fork and join nodes. A first one is the flow activity within a process, in which all child BPEL activities run concurrently. A second source is the implicit concurrent execution of BPEL processes in a composite web service. Although there is no explicit BPEL language construct for the second case, the concurrency can be modeled by adding a pair of fork and join nodes: the fork node has outgoing edges to the entry points of individual BPEL processes, and the join node has incoming edges from the exit point of these process.

A CPG edge is labeled with either a link attribute or a guard, e.g., a conditional expression under which the edge is executed. When β(ε)=link, we call the edge e a link edge. A link edge imposes a “happens-before” relation between the source and target nodes; that is, the target cannot be executed before execution of the source completes. The source and target nodes belong to different threads of the same BPEL process. Any edge that is not a link edge has a guard gεS_{cond}, which is true when the edge is not explicitly labeled.

A CPG edge may be associated with an action: an assignment statement asgnεS_{asgn}, a send, or a receive. The assignment asgn is of the form v:=exp; that is, the next-state value of v is the current value of expression exp. Expressions arising from BPEL specifications include integer and Boolean variables, together with typical arithmetic and relational operations. Each channel chεChl is associated with a unique pair of send and receive. We assume that both ch!x and Ch?y are blocking and the execution of send and receive be synchronous. Whenever asynchronous communication is needed, e.g., send is non-blocking and receive is blocking, we can model the asynchronous communication by explicitly adding a buffer thread to the channel. For example, a channel with arbitrary delay can be modeled by renaming the channel of send/receive into ch₁!x and ch₂?y and then adding a separate buffer thread.

The buffer thread may include the following transitions: a receive edge from node n₁ to node n₂, and a send edge from node n₂ to node n₁.

ch_1 ! x //original send
----
n1 -> n2 : ch_1 ? z //buffer thread
n2 -> n1 : ch_2 ! z
----
ch_2 ? y //original receive

The receive edge in the buffer thread reads in the message sent from ch₁!x, and then the send edge in the buffer thread relays the message to ch₂?y. Between receive and send, the buffer thread may introduce arbitrary delay (when the scheduler decides to execute threads other than this buffer thread).

The front-end translator 204 translates BPEL processes (202) to CPGs 206. A composite web service includes a set of interacting BPEL processes, each of which may have more than one thread. A root of a BPEL process is “process”, which includes an actual work flow defined by a top activity: Basic activities are receive, reply, invoke, assign, throw, terminate, wait, and empty. Structured activities are sequence, switch, while, pick, flow, scope, compensate.

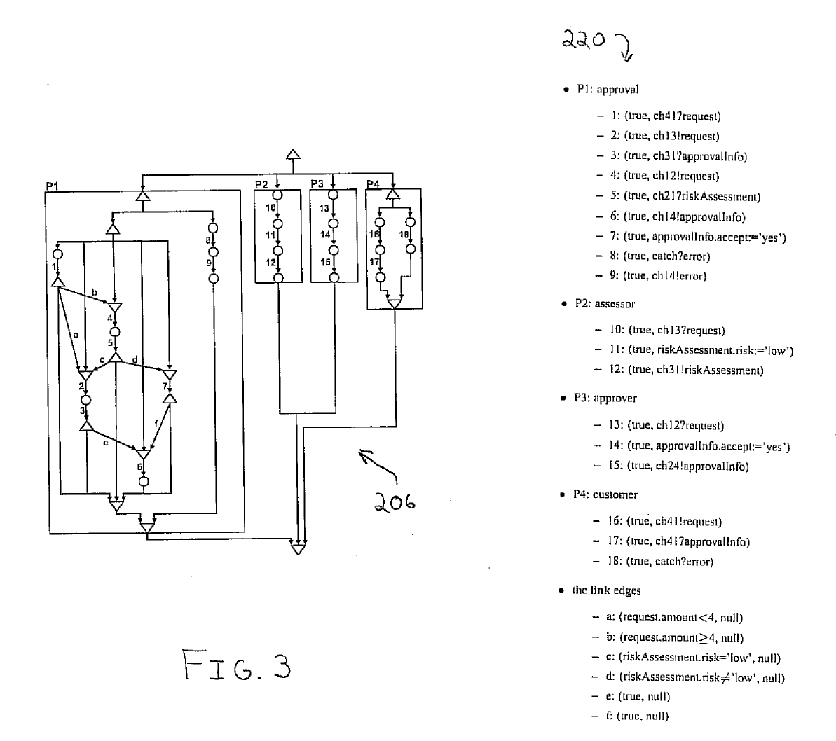

As an example, FIG. 3 shows a sample BPEL specification 202 (with simplified BPEL code). The entire system includes four interacting processes: approval, approver, accessor, and customer. The approval process is the main process which is invoked by the customer, and invokes the assessor and approver processes within a flow activity, in which five threads are activated simultaneously. All processes are executed concurrently and are interacting with the approval process.

The activities receive, reply, invoke are related to the sending and receiving of messages. Specifically, a receive activity in BPEL directly maps to a CPG receive action (ch?x) and a reply activity (as well as an asynchronous invoke) in BPEL directly maps to the CPG send action (ch!y). A synchronous invoke activity maps to a CPG send (ch!y) which is then immediately followed by a CPG receive (ch?x); that is, after sending a message y to invoke a remote service, it immediately waits for the returning message in x. The assign activity maps directly to a CPG assignment action (x:=exp). The terminate, wait, empty activities in BPEL can also be easily modeled by CPG nodes and edges.

The sequence activity in BPEL represents sequential execution of its child activities and is modeled by nodes of normal type. The switch, while, scope activities also map directly to corresponding structures in a standard control flow graph. The flow activity in BPEL represents concurrent execution of its child activities and is mapped to a pair of fork and join nodes in the CPG 206. The pick activity is similar to switch, except that control may transfer to its child activities in a nondeterministic fashion.

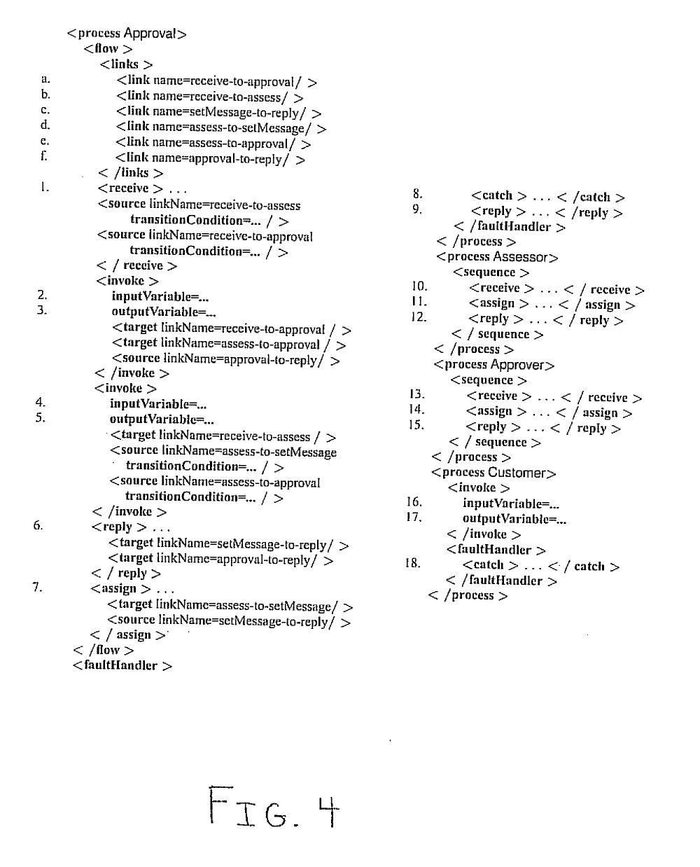

Now, we use the loanapproval example in FIG. 3 to show the modeling of BPEL concurrency constructs in CPG 206. Each edge in CPG 206 is labeled in the listing 220. An illustrative program corresponding to the loanapproval example is illustratively shown in FIG. 4.

When drawing the graph in FIG. 3, the following notation is used; let O denote a normal node, Δ denote a fork node, and ∇ denote a join node. There are ten threads in the graph. Note that inside approval and customer, a faultHandler also contributes a thread that runs concurrently with the main flow of the process. For clarity purposes, we omit the guards and actions on edges in this graph. They are shown below the graph along with other features of the approval process. Each CPG edge is denoted by the pair (guard, action).

A partial execution order on threads within a process can be specified by link attributes of the flow activity BPEL. For example, link a is between the receive activity and the invoke activity for invoking remote process P3. The guard of link a is (request.amount≧4), meaning that “the accessor process is invoked after the receive activity completes, and when the request amount is greater than or equal to 4”. As mentioned earlier, link can be modeled directly as a special CPG edge.

In the CPG of FIG. 3, the sequential depth is 15 and the number of CPG edges is 44. By sequential depth, we mean the number of steps in which a breadth-first search from an entry node can finish traversing all reachable states. In the following symbolic analysis, we will assume that interleaving semantics is imposed on the transitions of concurrently running threads/processes, in the CPG 206, e.g., only one transition is executed at a time. Under the interleaving semantics, symbolically traversing the state space of this particular CPU has a complexity of O(|E|) steps, where |E| is the number of CPG edges. A disjunctive encoding of the interleaving semantics tends to produce a simple transition relation (small in the size of the symbolic representation), which makes the symbolic fixpoint computation faster.

In block 208 (FIG. 2), a symbolic analysis is performed including symbolic encoding. The CPG 206 is analyzed using composite symbolic model checking. We assume that each thread Tᵢ has a dedicated program counter (PC) variable pc₁ for tracking the thread execution. We assume that X is the set of state variables, including the PC variables of all threads, the program variables of all threads, and other auxiliary variables for modeling the concurrent semantics.

Each node nεN is associated with the following fields:

n.tid is the thread id (i if n belongs to Tᵢ);

n.pc is the PC variable (pc₁ if n belongs to Tᵢ)

n.id is the node index (a constant);

n.type is the node type (normal, fork, or join);

n.Eᵢₙ is the set of incoming edges;

n.Eₒᵤₜ is the set of outgoing edges.

Each edge eεE is associated with the following fields:

e.src=n₁ is the source;

e.tgt=n₂ is the destination;

e.link indicates whether e is a special link edge;

e.cond is the condition;

e.action is the action (assignment, ch!y, or ch?x)

e.X_{w} is the set of state variables being written to;

e.X_{R} is the set of state variables being read from.

We denote an edge by (n₁,n₂,true,-). When action e.a₁₂ is ch!expr, variables in the support of expr belong to e.X_{R}. When action e.a₁₂ is ch?x variable x belongs to e.X_{w}.

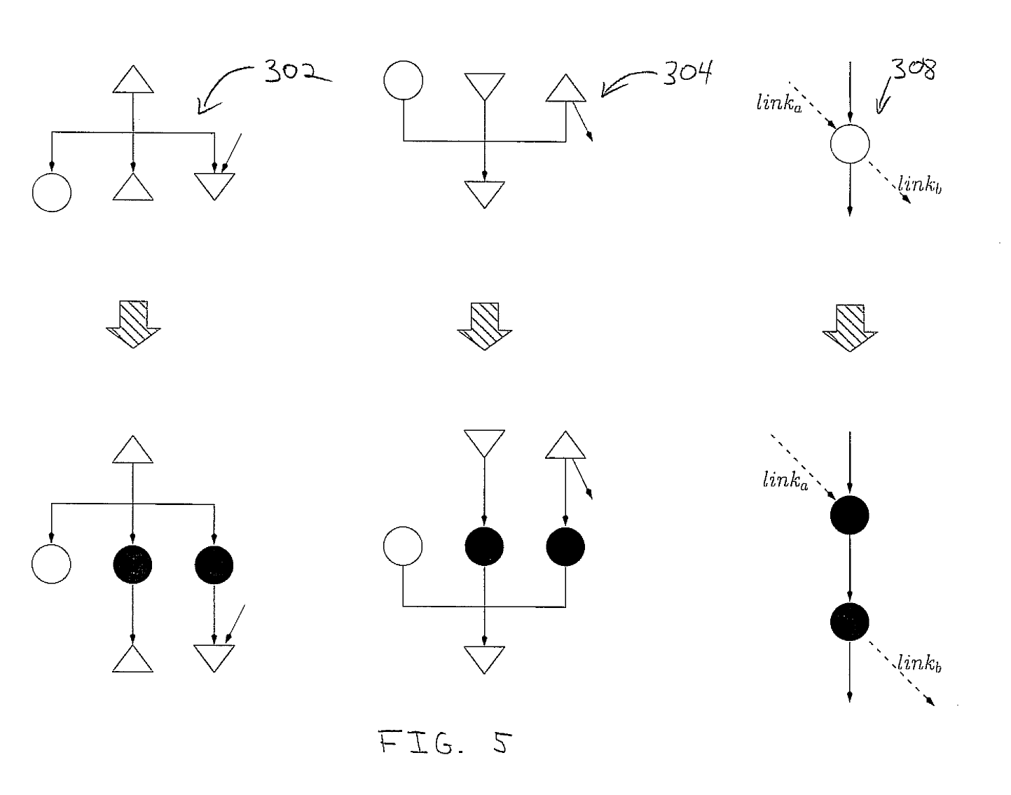

To ease the symbolic encoding of interleaving semantics in block 208, we impose the following constraints on the CPG 206. Without loss of generality, if a given CPG does not obey the constraints, we rewrite it into a functionally equivalent form that obeys these constraints. In particular, we assume the following requirements hold for all n₁εN:
If n₁.type=fork, then for all edges e:(n₁, n₂, c₁₂, a₁₂)εn₁.Eₒᵤₜ, we have c₂₁=true and a₁₂ does not have action; otherwise, we insert a new node n₃ between n₁ and n₂ (See FIG. 5 rewriting a fork 302).
If n₁.type=join, then for all edges e:(n₁, n₂, c₁₂, a₁₂)εn₁.Eᵢₙ, we have c₂₁=true and a₂₁ does not have action; otherwise, we insert a new node n₃ between n₂ and n₁ (See FIG. 5 rewriting a join 304)
Among the two sets n₁.Eᵢₙ and n₁.Eₒᵤₜ, at most one set includes special link edges; otherwise, we split the node into n₁ₐ such that n₁ₐ.Eᵢₙ and n_{1b}.Eₒᵤₜ=n₁.Eₒᵤₜ (See FIG. 5 rewriting a link 308).

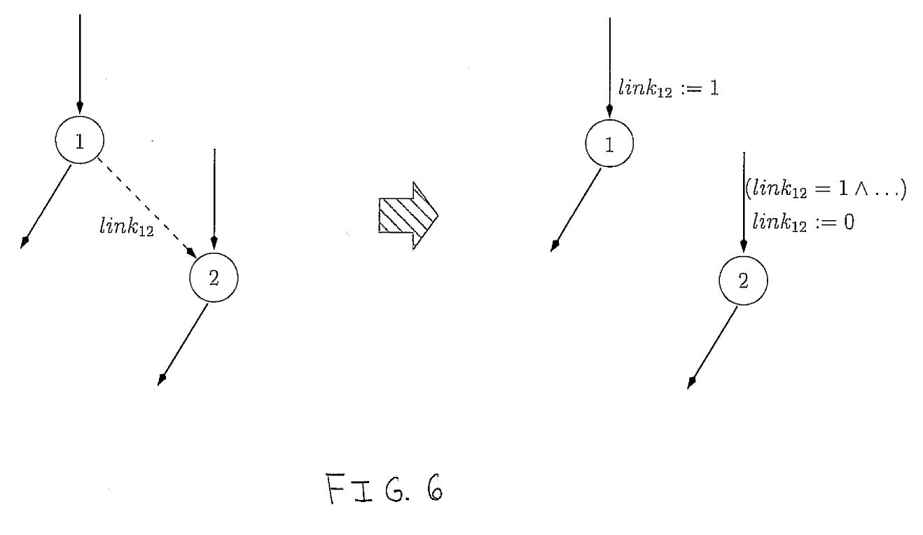

Referring to FIG. 6, we also use graph rewriting to remove the link edges in a given CPG. For each link or lk from n₁ to n₂ we allocate a new binary state variable lk₁₂ (variable lk₁₂ is added to X).
First, we add the assignment lk₁₂=21 as an action to all the normal incoming edges in n₁.Eᵢₙ.
Second, we add the guard (lk₁₂=1) to all normal incoming edges in n₂.Eᵢₙ.
Third, we add the assignment lk₁₂:=0 as an action to all the normal outgoing edges in n₂.Eₒᵤₜ.
Finally, if the link has a transition condition, we also add it as a guard (by conjoining with existing guards) to all the normal incoming edges in n₂.Eᵢₙ.

Assigning PC Variables: As described above, each thread in the CPG 206 is associated with a distinct PC variable, for the purpose of tracking the thread execution. The assignment of PC variables is not assigned in the original CPG, and they are related to the interleaving semantics that we choose for the analysis. Therefore, we traverse the graph and identify for each CPG node, the thread it belongs to. We assume that in the CPG, thread creation and termination (corresponding to fork and join) are always nested; that is, if thread B is forked from thread A, then thread B should join back before thread A terminates. Whenever a CPG is produced from a BPEL process, this assumption is guaranteed to hold. The assumption significantly simplifies the method for assigning PC variables. Consequently, we can perform a depth-first search of the graph, and assign new PC variables only when visiting the following nodes: 1) entry node of process, 2) every successor of a fork node, except for the first one. All other nodes, including the first successor of a fork node, belong to the same thread as their predecessor node that has the smallest thread index.

Methods 1 and 2 show illustrative pseudo code, where ASSIGN_PCVAR is the entry point of a procedure. In this procedure, num PC represents the total number of PC variables in the graph (which is initialized to 1). The auxiliary field n.visited is used for the purpose of depth-first searching. We store the result of this computation, that is, to which thread each node belongs, at n.pc. Recall that for nεN, n.pc. stores the PC variable pcᵢ.

METHOD 1: ASSIGN_PCVAR (G)

1. for each node n ∈ N do
2. n.pc. = NULL
3. n.visited = 0;
4. end for
5. numPC = 1;
6. ASSIGN_PCVAR_DFS(G.entryNode);

Method 2: ASSIGN_PCVAR_DFS(n₁)

1: If n₁.visited == 0 then
2: n₁.visited = 1;
3: if n₁.pc == NULL then
4: n₁.pc = numPC;// assigning a new PC var
5: numPC= numPC +1;
6: end if
7: for each e ∈ n₁.Eₒᵤₜ do
8: n₂ = e.tgt ;
9: if n₂.type == fork then
10: if e is the first edge in n₁.Eₒᵤₜ then
11: n₂.pc = n₁.pc ;
12: end if
13: else if e.type == join then
14: if n₂.pc == NULL or n₂.pc > n₁.pc then
15: n₂.pc = n₁.pc ;
16: end if
17: else
18: if n₂.pc == NULL then
19: n₂.pc = n₁.pc
20: end if
21: end if
22: ASSIGN_PCVAR_DFS(n₂)
23: end for
24:end if

Disjunctive Transition Relation: In symbolic model checking, the model is represented as a tuple [symbol] I,T [symbol] where I is the characteristic function of initial states and T is the transition relation. X is the set of state variables, and X′ includes the next-state copies of variables in X. Assume that the CPG has a unique entry node n₁εN, then I is defined as (n₁.pc=n₁.id)̂ [symbol] _{pc}_{ᵢ}_{≠n}_{₁}_{.pc} (pcᵢ=⊥). In the initial state, all the yet-to-be-created threads have a PC value ⊥. Furthermore, after a thread terminates through execution of a join edge, its PC value becomes ⊥ again.

The concurrent semantics is imposed by using a nondeterministic scheduler variable called sel, whose domain is the set of thread indices in the CPG. An edge eεE, whose source node belongs to thread Tᵢ(e.src.pc=pcᵢ), is executed only when (sel=i). Also note that when an edge eεE is executed, state variables that are not assigned new values on this edge retain their current values. According to the synchronous communication semantics, we model the synchronous execution of ch!y and ch?x as if there is an assignment x′:=y (the next-state value of x is current value of y) added to T. This assignment (synchronous execution of send and receive) happens only when both threads are ready to communicate—when the PC of the send thread is at the source node of the send edge and the PC of receive thread is at the source node of the receive edge. If one thread is ready for a send ch!y, but the other thread is not yet ready for ch?x (or vice versa), no transition from these two threads will be executed since there is no corresponding transition formula in T.

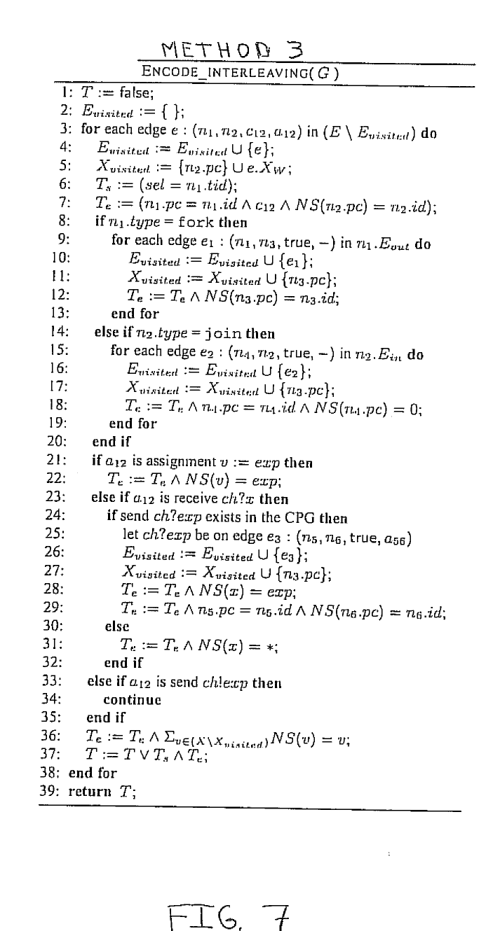

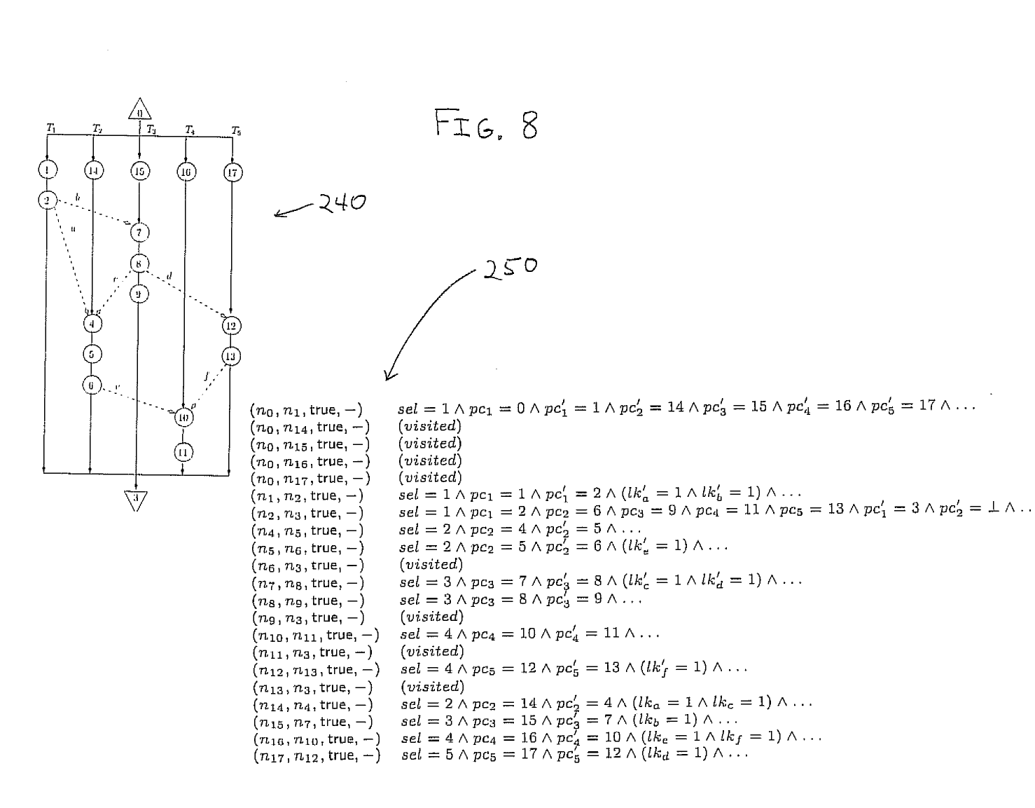

A method (method 3 in FIG. 7) for building the disjunctive transition relation T is illustratively shown in the form of a pseudo-code program. Let T= [symbol] _{eε}E Tₑ where Tₑ is the transition relation for an individual edge eεE. We start by iterating through the set E of CPG edges. The pseudo code of this procedure is given in Method 3 depicted in FIG. 7. Here E_{visited} denotes the subset of already visited edges. For each edge eεE, we use X_{visited} [symbol] X to denote the subset of state variables that are assigned, either explicitly through actions or implicitly through control flow transition. We do not add transition formula T for send edges—these formulae are added when processing the corresponding receive edges. As an example, the result of applying method 3 to the CPG 206 in FIG. 3 is given in FIG. 8, which shows symbolic encoding 250 of the interleaving semantics for a portion 240 of the example CPG 206.

Monolithic Model Checking: For a BPEL, process without any external service invocation, we can model the process as a CPU, build a monolithic verification model and check its correctness by model checking. For a composite web service in which a BPEL process invokes a set of externally defined BPEL processes, we can build a single CPG that includes all participating BPEL processes by adding a new entry node which is a fork, with outgoing edges to the entry nodes of all participating processes; at the same time, adding a new exit node which is a join, with incoming edges from the exit nodes of all participating processes. In the monolithic verification model, all variables are treated as global variables; the model is treated as a closed system.

Given the verification model, we can apply a standard symbolic fixpoint method for the reachability analysis. Let R be the set of reachable states from I in the model; we start with R=I, and repeatedly compute R∪post(T,R) is the set of successor states of R.

In symbolic model checking, post(T,R) is defined as (∃X.R(X)̂T(X.X))[X/X]. Maintaining the entire reachable state set Rⁱ at every iteration i is costly. However, to detect convergence of this fixpoint computation, the fixpoint computation needs to store the already reached states (to stop as soon as (Rⁱ⁺¹=Rⁱ). Let Rⁱ⁻¹ and Rⁱ be two reachable state sets at two consecutive steps; the set Rⁱ\Rⁱ⁻¹ is called a frontier set. In computing Rⁱ⁺¹, post(T,Rⁱ\Rⁱ⁻¹) can be used instead of post (T, Rⁱ) to speed up the computation, if the set (Rⁱ\Rⁱ⁻¹) has a smaller symbolic representation.

We apply a specialized symbolic search strategy called REACH_FRONTIER to improve the reachability fixpoint computation. It uses an augmented frontier set to detect convergence. In the reachability computation, a frontier set includes all the new states reached at the previous iteration; that is, F⁰=I, Fⁱ=post(T,Fⁱ⁻¹)\Fⁱ⁻¹. When the CPG is an acyclic graph, the fixpoint computation can stop when Fⁱ becomes empty. In the presence of cycles, we can identify a set of back edges E_{back} [symbol] E in the CPG, whose removal will make the graph acyclic. Let Spa= [symbol] _{eεE}_{_{back}} (e.src.pc=e.src.id) denote the state subspace associated with source nodes of the back edges. The set of already reached states that falls inside Spa is S=R∩Spa; the emptiness of the set (F\R∩Spa) can be used to detect convergence.

We identify back edges in the CPG by a Depth-First Search (DFS) starting from the entry node. If the CPG is acyclic, the post-order of DFS gives topological order and all edges are from lower ranked nodes to higher ranked nodes. If the CPG has cycles, E_{back} is identified as the set of edges from higher ranked nodes to lower ranked nodes (with respect to the post-order of DFS) and label them as back edges. The removal of these edges makes the CPG a directed acyclic graph.

Our new reachability procedure in Method 4 takes as parameters the state subspace Err as well as Spa associated with tail blocks of back edges E_{back}. We use set S to represent the subset of already reached states that falls inside Spa. The Frontier procedure terminates whenever the standard fixpoint procedure terminates.

METHOD 4 REACH_FRONTIER (T,I,Err,Spa)

1: F = I
2: S = I ∩ Spa :
3: while F ≠ 0 do
4: if(F ∩ Err)≠ 0 then
5: return false;
6: end if
7: F =(post(T,F)\F)\S;
8: S = S ∪(F ∩ Spa);
9: end while
10: return true;

The symbolic analysis presented here is well suited for handling each individual BPEL process, for which the size of CPG and the number of concurrent threads is often small. When applied to a composite web service, such a monolithic verification method may suffer from the state explosion problem, similar to the prior methods using automata product construction. We present a modular verification method, which analyzes BPEL processes individually before composing them together to verify the entire system.

MODULAR VERIFICATION OF SERVICE COMPOSITION: Referring again to FIG. 2, given a set of interacting processes, an interface library which is a set of process summaries in block 212. Without loss of generality, we consider a process P with a unique receive action and a unique send action. The method is readily extendable to processes with more than one pair of incoming/outgoing messages. We focus on safety properties such as invariants and reachability of certain error nodes in the CPG 206. These error nodes can be due to assertions in the source code or added by checker instrumentation.

For a process P, we use P.pre to represent the safe invoking contexts of P, and use P.post to represent the expected outcome of P. Since processes communicate by sending/receiving messages only, P.pre is a predicate over the set of incoming messages to P, and P.post is a relation of the incoming and outgoing messages.

DEFINITION: The summary of a process P includes the following components [symbol] msgᵢ, msg₀, pre, post [symbol] where msgᵢ is a set of incoming messages, msg₀ is a set of outgoing messages, pre(msgᵢ) is a predicate over variables in msgᵢ, and post(msgᵢ,msg₀) is a predicate over variables in msgᵢ and msg₀.

P.pre denotes the condition under which invoking P is guaranteed not to cause a failure inside P. If P.pre holds then it implies that local assertions inside P always hold. P.post includes all the expected results of invoking the process; it is a symbolic representation of the complete relation among input/output variables.

Computing Process Summaries: Given a symbolic model (block 208) [symbol] I,T [symbol] for a process P, both P.pre and P.post can be computed by symbolic fixpoint computations. Let {X=msgᵢmsg₀,X_{local}} be the set of state variables, in which X_{local} includes all the local state variables in P. The transition relation of P is T(X,X′), defined in terms of the current-state variables X and the next-state variables X′. Since msgᵢ and msg₀ are state variables, and they do not change in any transition inside P, we need to add the constraint (msgᵢ′=msgᵢ̂msg₀ᵢ′=msg₀) to every disjunctive transition component in T(X,X′) except the send and receive edges. This constraint is used to make sure that when these transitions are executed, both msgᵢ and msg₀ retain their values. Furthermore, receive and send are encoded in a slightly different way from the monolithic case in METHOD 3. For example, ch1?x is encoded as x′=msgᵢ; ch2!y is encoded as msg₀′=y.

P.pre and P.post are associated with the corresponding send and receive edges inside P. Let nᵢₙεN be the node right before ch1?x and nₒᵤₜεEN be the node right after ch2?y; then Sᵢₙ=(nᵢₙ.pc=nᵢₙ.id) denotes the set of possible states at node nᵢₙ, and Sₒᵤₜ=(nₒᵤₜ.pc=nₒᵤₜ.id) denotes the set of possible states at node nₒᵤₜ. The method for computing P.pre as a least fixpoint via backward reachability analysis is given as follows:

let B₀=Err, P.pre=true

repeat Bᵢ=pre (T, Bᵢ₋₁) and P.pre=P.p\(Bᵢ∩Sᵢₙ)

until Bᵢ\Bᵢ₋₁0.

This is the symbolic representation of states that satisfy the conjunction of the weakest pre condition of each local assertion. The method for computing P.post as a least fixpoint via forward reachability analysis is given as follows:

Let R₀=I, P.post=0

repeat Rᵢ=post(T,Rᵢ₋₁) and P.post=(Rᵢ∩Sₒᵤₜ)∪P.post

until Rᵢ\Rᵢ₋₁=0.

P.post=P.post̂P.pre

It is worth noting that P.pre and P.post can also be derived via standard Hoare logic rules; however, there is a significant drawback of such approach when it is applied to a multi-threaded system. Due to the interaction of concurrently running threads, one needs to consider all possible sequentialized transactions in the derivation, which are likely to cause a blow-up. Note that the state space of a concurrent system is O(2″), but the number of sequentialized execution paths is O(2^{2″}) in the worst case. Here n is the number of concurrent operations.

Composing Process Summaries: The summary of process P₁ is applied when analyzing the invoker process P₂, so that the invocation of P₁ in P₂ is treated as if it is a single transition step in P₂. This occurs in block 210 of FIG. 2.

Recall that a synchronous invoke(ch,x,y) in BPEL is translated into an edge e_{send}=(n₁,n₂,true,ch1!x), followed immediately by an edge e_{recv}=(n₂,n₃,true,ch2!y). For an asynchronous invoke (ch,x), the translation is similar, except that these send and receive edges are not consecutive. For the purpose of composing an external process summary, there is no fundamental difference between synchronous and asynchronous and asynchronous invocations.

Given a pair of edges e_{send} and e_{recv} in the invoker process P₂, and a summary of the invoked process P₁, we model the corresponding action of P₂ as follows:
1. For e_{send}
   Encode ch1!x as (msgᵢ′=x)̂P₁.pre(msgᵢ′);
   add guard (msgᵢ′=x) [symbol] [symbol] P₁.pre(msgᵢ′) for detecting error in P₁.
2. For e_{recv}, encode ch2?y as (y′=msg₀) [symbol] ₁.post(msgᵢ,msg₀).
3. For all the other edges in P₂, conjoin the constraint (msgᵢ′=msgᵢ) to their transition relation.

The first step (1) above is constructing the guarded condition to invoke the service safely. This is done by conjoining P₁.pre of the service to the send edge of P₂. Note that if the guard is not satisfied, the service cannot be invoked safely. To alarm the violation of P₁.pre during invocation, we add an edge to an error node in the invoker process P₂ which we use to identify the error.

The second step (2) above is adding the assignment as the consequence of invoking the service. The encoding ensures that after a successful invocation the value of y after ch2?y is defined by the P₁.post of the invoked process. Recall that P₁.post(msgᵢ,msg₀) is a relation over the incoming and outgoing messages, where msgᵢ is the snapshot of value of x in ch1!x. Note that the auxiliary variables in P₁.msgᵢ, P₁,msg₀, used for the invocation of P₁, are tested as local variables in process P₂. In invoker process P₂, while the edges other than ch1!x and ch2?y are executed, we ensure that the value of msgᵢ is preserved—therefore we need to conjoin msgᵢ′=msgᵢ to all disjunctive transition components in T.

After replacing synchronous and asynchronous invocations as normal guarded edges, we can generate the transition relation based on the encoding defined above. By composing external services, we can analyze BPEL processes individually. Compared to monolithic verification, the worst-case complexity is reduced from |P₁|×|P₂| . . . |Pₙ| to

$${\sum }_{k} \vert {P}_{k} \vert \times {\prod }_{j \neq k}^{ } \vert {P}_{j} \cdot msg \vert ,$$

where Pₖ is the k-th process and Pⱼ.-msg is the set of auxiliary variable used to temporarily store the input/output messages for invoking the j-th process.

For those services for which we do not have summaries, we can adopt a conservative encoding to allow all possible behaviors, e.g., we define both P.pre and P.post as true. Since this does not add restriction to msgᵢ and msg₀, the value of y in ch2?y becomes nondeterministic.

### Example 1

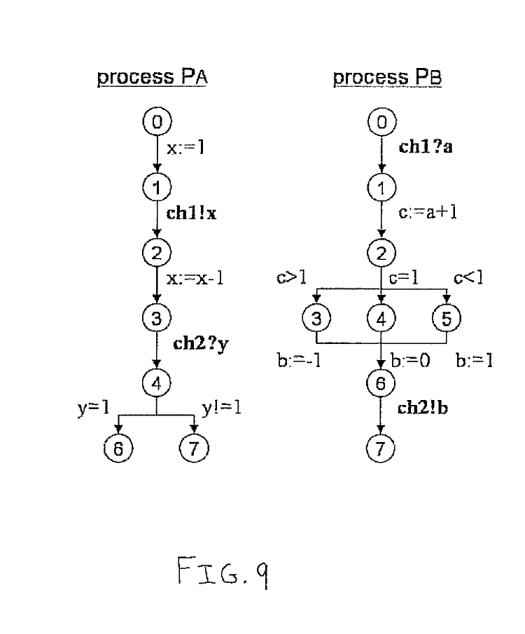

There are two processes shown in FIG. 9, in which process P_{A} invokes process P_{B}. Node values are given in circles. The summary of P_{B} on the right-hand side is

P_{N}.pre=true,

P_{B}.post=(msgᵢ>0 [symbol] msg₀=+1)

[symbol]

(msgᵢ,>0 [symbol] msg₀=0)

[symbol]

(msgᵢ,>0 [symbol] msg₀=−1)

After composing the summary of P_{B}, the transition relation of process P_{A} on the left-hand side is

n₁ → n₂: (sel=1) [symbol] (pc₁= [symbol] pc₁′2) [symbol] (msgᵢ′=x)

n₂ → n₃: (sel=1) [symbol] (pc₁=2 [symbol] pc₁′=3) [symbol] (x′=x−1 [symbol] msgᵢ′=msgᵢ)

n₃ → n₄: (sel=1) [symbol] (pc₁=3 [symbol] pc₁′=4) [symbol] (y′=msg₀ [symbol] P_{B}.post(msgᵢ,msg₀)).

Proof of Correctness: A state s is a mapping function: V → Dom, where Dom denotes the domain of the mapped variable. A variable vεV is constant in process P if (v′=v) holds in all transitions of the process. The following lemma shows that we can use the reachable states of a process as a summary, since it is a symbolic representation of the relation of incoming messages and outgoing messages. The lemma also shows that the summary is precise. The key is to separate from the set of state variables of the model, the variables that represent the messages to and from the process. Note that these message variables do not change their values in any transition of the process. In the sequel, let x be the set of state variables, and Xᵢ⊂X be the message variables.

Lemma 1: post*(T,S)=Sᵢ [symbol] post*(T,S_{g}) if (1) X=Xᵢ∪X_{g}.S(X)=Sᵢ(Xᵢ) [symbol] S_{g}(X), and (2) T(X,X′) is the transition relation, in which variables in Xᵢ are constant.

According to lemma 1, given the set I_{g}(X) of reachable states of a process, one can compute the fixed point of reachable states for a specific initial condition in the form Iᵢ(Xᵢ) [symbol] I_{g}(X) by simply conjoining Iᵢ(Xᵢ) with the set of reachable states from I_{g}(X). When I_{g}(X) is fixed, the set of reachable states from I_{g} can be calculated in advance and serve as the summary of the process.

In our case, for the invoked process P₁.X includes the local state variables as well as msgᵢ and Xᵢ=msgᵢ. The summary P₁.post(msgᵢ,msg₀) is equal to post *(T,S_{g}). In the invoker process P₂, there is a constraint Sᵢ(Xᵢ) right before invoking process P₁; this constraint is preserved in all the subsequent transitions due to (msgᵢ′=msgᵢ). Upon receiving the message msg₀ from P₁, we combine P₁.post(msgᵢ,msg₀) with the constraint Sᵢ(Xᵢ) to get the result of post *(T,Sᵢ [symbol] S_{g}).

Note that we avoid computing the standard transitive transition closure (T*) in obtaining a precise process summary. Building the transition relation T for the invoked process P₁, and then computing its transitive closure will produce a precise process summary as well. However, since such computation manipulates sets of transitive transitions as opposed to sets of reachable states, it is more likely to blow up. In practice, we have observed that the transitive transition closure computation is more expensive than computing the set of reachable states.

Implementation: We have developed a prototype tool to implement the proposed modular verification method. The tool consists of the following components: (1) Translator for BPEL+WSDL to CPG, (2) Composite Symbolic Model Checker. (3) Summarizer/Modular Verifier.

Experimental Results: We conducted experiments on two public benchmarks: loan approval and travel agency. We were able to reduce the runtime by 90% (from 1227.2 seconds to 124.5 seconds) and reduce the memory usage by 40% (from 810 MS to 490 MB) using the modular verification method instead of monolithic verification. The preliminary results showed that the present modular verification method outperforms the conventional monolithic verification in terms of both performance and scalability.

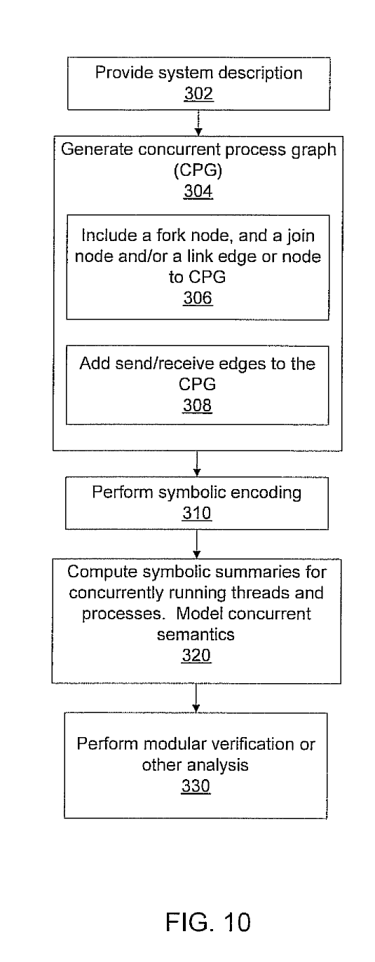

Referring to FIG. 10, a system/method of verification of services in a distributed system is depicted. A distributed system may include a network system, such as the Internet or the Web. Web services include different modules or applications cooperating to provide benefit or function for a user or group of users. Such applications are created to interact with other applications by communicating using messages. An application can invoke another which can invoke others and so on. The complexity of such relationships with concurrent activities makes verification of such systems difficult. The following method may be employed to verify an entire system of processes by separating the processes and verifying these one at a time to permit verification of the entire system. A processors and memory storage system are preferred hardware devices employed in providing the verification described herein.

In block 302, a system description is provided for a plurality of processes to be executed concurrently. In block 304, a concurrent process graph (CPG) for the plurality of processes is generated. This may be performed using a translator to generate the CPG. In block 306, the CPG includes at least one of a fork node, a join node and a link edge to model the concurrent threads and processes. In block 308, send and receive edges may be added to the CPG to model the concurrent threads in message passing among processes.

In block 310, symbolic encoding of the CPG is performed to build symbolic transition relations for the plurality of processes. This is preferably performed by constructing the transition relations in a disjunctive form.

In block 320, symbolic summaries are computed for concurrently running threads and processes based on model checking and reachability analysis. This may include modeling concurrent semantics of shared-variable multi-threading with a process and/or modeling concurrent semantics of synchronous and asynchronous invocations of remote processes. Symbolic reachability analysis is conducted using frontier-set based fixpoint computation with a composite symbolic library. Bounded model checking using a Satisfiability Modulo Theory (SMT) solver may be employed. The symbolic summaries of a process may be computed in accordance with incoming and outgoing messages. A summary of an invoked process is used to build a transition relation of an invoker process.

In block 330, modular verification is conducted for service composition by computing and utilizing the symbolic summaries of the threads and processes to provide a modular and scalable verification of a system of interrelated processes. The verified processes may then be employed by network users searching or using the composite services. For example, in a distributed system such as the internet, composite services or pieces of an overall service are distributed over the network. When a user employs such a service, incompatibilities may exist between processes of each piece. The present invention includes a tool for determining or verifying proper operation of a given service.

Having described preferred embodiments for modular verification of web services using efficient symbolic encoding and summarization (which are intended to be illustrative and not limiting), it is noted that modifications and variations can be made by persons skilled in the art in light of the above teachings. It is therefore to be understood that changes may be made in the particular embodiments disclosed which are within the scope and spirit of the invention as outlined by the appended claims. Having thus described aspects of the invention, with the details and particularity required by the patent laws, what is claimed and desired protected by Letters Patent is set forth in the appended claims.

What is claimed is:

1. A method for verifying a composition of interacting services in a distributed network system, comprising:
generating a concurrent process graph (CPG) for processes in a system;
symbolically encoding the CPG of each process to perform a reachability analysis;
generating symbolic summaries for concurrently running processes based on the reachability analysis; and
conducting modular verification by utilizing the symbolic summaries of the processes to verify a system of interrelated processes.

2. The method as recited in claim 1, wherein symbolically encoding the CPG includes constructing the transition relations in a disjunctive form.

3. The method as recited in claim 1, wherein symbolically encoding the CPG includes modeling concurrent semantics of shared-variable multi-threading within a process.

4. The method as recited in claim 1, wherein symbolically encoding the CPG includes modeling concurrent semantics of synchronous and asynchronous invocations of remote processes.

5. The method as recited in claim 1, wherein generating symbolic summaries includes conducting a symbolic reachability analysis using a frontier-set based fixpoint computation.

6. The method as recited in claim 1, wherein generating symbolic summaries includes conducting bounded model checking using a Satisfiability Modulo Theory (SMT) solver.

7. The method as recited in claim 1, wherein generating symbolic summaries includes computing the symbolic summaries of a process in terms of incoming and outgoing messages.

8. The method as recited in claim 1, wherein a summary of an invoked process is used to compute the summary of an invoker process.

9. The method as recited in claim 1, wherein generating a concurrent process graph (CPG) includes an addition of at least one of a fork node, a join node and a link edge to model the concurrent threads and processes.

10. The method as recited in claim 1, wherein generating a concurrent process graph (CPG) includes adding send and receive edges to model message passing among processes.

11. A computer readable medium comprising a computer readable program, wherein the computer readable program when executed on a computer causes the computer to perform the step of claim 1.

12. A method for analyzing a composition of interacting services in a distributed system, comprising:
generating a concurrent process graph (CPG) for processes in a system;
symbolically encoding the CPG of each process to perform a reachability analysis;
generating symbolic summaries for concurrently running processes based on the reachability analysis; and
utilizing the symbolic summaries of the processes to analyze a system of interrelated processes.

13. The method as recited in claim 12, wherein symbolically encoding the CPG includes constructing the transition relations in a disjunctive form.

14. The method as recited in claim 12, wherein symbolically encoding the CPG includes modeling concurrent semantics of synchronous and asynchronous invocations of remote processes.

15. The method as recited in claim 12, wherein generating symbolic summaries includes computing the symbolic summaries of a process in terms of incoming and outgoing messages.

16. The method as recited in claim 12, wherein generating a concurrent process graph (CPG) includes an addition of at least one of a fork node, a join node and a link edge to model the concurrent threads and processes.

17. The method as recited in claim 12, wherein generating a concurrent process graph (CPG) includes adding send and receive edges to model message passing among processes.

18. The method as recited in claim 12, wherein utilizing the symbolic summaries of the processes to analyze a system of interrelated processes includes optimizing the system.

19. A system for verification of services in a distributed system, comprising:
a concurrent process graph (CPG) generated for the plurality of processes in a distributed system;
a symbolic encoder configured to symbolically encode the CPG of each process to perform a reachability analysis;
a library of process summaries stored in a memory media, the process summaries representing concurrently running threads and processes based on reachable states; and
a modular verifier configured to perform service composition by computing and utilizing the process summaries of the processes to modularly analyze an entire system of processes to determine dependencies and order of execution for the entire system of process.

20. The system as recited in claim 19, wherein the symbolically encoder builds symbolic transition relations by constructing the transition relations in a disjunctive form.

21. The system as recited in claim 19, wherein the process summaries include summaries of a process in accordance with incoming and outgoing messages.

22. The system as recited in claim 19, wherein the concurrent process graph (CPG) includes at least one of a fork node, a join node and a link edge to model the concurrent threads and processes.

23. The system as recited in claim 19, wherein the CPG for the plurality of processes includes send and receive edges to model the concurrent threads in message passing among processes.
